(19) United States
(12) Patent Application Publication
(10) Pub. No.: US 2003/0142579 A1
(43) Pub. Date: Jul. 31, 2003

(54) Mobile pavement plant

(76) Inventor: Jeffrey L. Throop, Sierra Madre, CA (US)

Correspondence Address: Western Patent Group, 6020 Tonkowa Trail, Georgetown, TX, 78628, US

(21) Appl. No.: 10/058,178

(22) Filed: Jan. 29, 2002

(51) Int. Cl. B28C 1/16; E01C 7/00

(52) U.S. Cl. 366/3; 366/6; 366/10; 366/13; 366/34; 366/50; 427/136

(57) ABSTRACT

Provided herein are combinations of equipment capable of providing the continuous fabrication of road surfaces and the like, by virtue of the continuous manufacture of the concretes used in making the road surface at their point of use. The invention also includes a process for fabricating a road surface or the like. By the present invention it is now possible to provide a greater quantity of road surface in a shorter amount of time as provided for in the prior art, wherein the road surface has a quick-cure time owing to the use of quick-setting cements. Such quickly laid roads are capable of handling loads of about 100,000 lbs. within about 2 hours of its being fabricated and laid in place.

Additionally, through use of the present invention the need for ready-mix trucks is eliminated. Further, consistency of concrete is enhanced by elimination of transporting batches of concrete from their production locations remote from the point of use, which use of different batches in the prior art has resulted in lot-to-lot variations in concrete quality. The present invention eliminates waste, cold joints and affords a high degree of the control of slump. The surface making process may be started and stopped at will without regard to incoming ready-mix as was a consideration in the prior art methods, longer production runs are possible, and the concrete surfaces produced have enhanced uniformity over the prior art. Production runs are limited only by the number of machines and time through use of the invention, and road repair/laying may be done in much shorter time over prior art methods, making the present invention uniquely attractive in night repair or construction of important roads frequently traveled by commuters during daylight hours.

This invention relates to the manufacture of road surfaces and the like, including the patching of existing roads, as well as the fabrication of new road surfaces, airports, and any pavement where rapid strength is desired. More particularly, it relates to a combination of equipment capable of providing the continuous fabrication of road surfaces and the like, by virtue of the continuous manufacture of the raw material used in making the road surface at its point of use. The invention also includes a process for fabricating a road surface or the like, and by the present invention it is now possible to provide a road surface that has a quick-cure time and is capable of handling loads of about 100,000 lbs. within about 2 hours of its being fabricated and laid in place.

### BACKGROUND

Various pieces of heavy equipment have been designed for the laying and paving of various materials for use as a road surface or the like, such as the many cements and asphalt compositions which are known to those skilled in the art. However, the contrivances of the prior art have been focused primarily on equipment which is capable of manipulating a pre-mixed concrete or asphaltic substance which is transported to the site of its intended use by other vehicles, such as a dump truck or other truck. These prior art machines are, in general, capable of paving, distributing, flattening, mixing, heating or otherwise treating a raw material from which a road surface may be fabricated. For example, U.S. Pat. No. 2,885,934 teaches a vehicular apparatus for effecting in-place mixing of soils and aggregates with a suitable stabilizing agent comprising a moveable frame, a cylindrical rotor mounted on the frame for rotation about a transverse horizontal axis. The rotor has circumferentially disposed wall sections at spaced intervals to provide openings alternating with the wall sections. There is a transverse spray pipe disposed on the frame in coaxial relation with respect to the rotor and provided with spray orifices along its length for uniformly distributing the stabilizing agent to the soils and aggregates lengthwise of the rotor through the openings between the wall sections of the rotor. There is a driving means for the rotor and a plurality of circumferentially spaced elements projecting outwardly from the rotor and extending substantially the width of the frame for pulverizing the soils and aggregates and mixing them with the stabilizing agent delivered from the spray pipe. U.S. Pat. No. 3,561,335 discloses a device with a frame that is adapted to move in the longitudinal direction over the surface of a road upon which mixed materials are to be spread. the frame mounts a transversely oriented chamber which is provided with a pickup opening and a discharge opening at its opposite extremities a mixing means in the chamber is operative to pull into the chamber materials arranged in a window upon the road surface. The mixing means also is operative to lift and thrust the materials transversely and inwardly through the chamber in a generally suspended state. The discharge opening permits the mixed materials to be deposited on the road surface, and a spreading means on the frame rearwardly of the chamber is arranged to spread the deposited materials transversely and outwardly. U.S. Pat. No. 3,986,708 provides a mobile batching plant comprising: a) a primary frame; b) a plurality of separable modular secondary frames connected in tandem draft alignment with the primary frame; c) a cement modular frame, hopper, storage; weighing and conveying means pivotally mounted on top of the primary frame; d) an aggregate hopper and dispensing gate therefor carried by each separable modular secondary frame; e) a first aggregate conveyor means carried by the modular secondary frames and positioned beneath the dispensing gates of each aggregate hopper; f) a second aggregate conveyor means carried by the primary frame and positioned beneath the cement conveying means at one end and positioned to receive aggregate from the first aggregate conveyor means; g) mixing means carried by the second aggregate conveyor frame positioned to receive cement from the cement conveyor and aggregate from the second aggregate conveyor, and h) a fifth wheel draft connection carried by the primary frame and transport wheel means connected to the rear of the last of the separable modular secondary frames for moving the plant over the highway from site to site. U.S. Pat. No. 3,998,436 teaches a mobile concrete batch plant for supplying a properly proportioned homogenous mix of cement and aggregate (including sand) to a mix truck from an elevated discharge hood comprises a weigh bin for receiving and weighing aggregate from an aggregate storage bin and for depositing a weighed batch of aggregate onto a belt conveyor for transport to and discharge from a discharge opening in the discharge hood. The plant further comprises a combined screw conveyor and weigh batcher for receiving and weighing cement from a cement storage bin and for transporting and discharging a weighed batch of cement through a cement pipe concentric of the discharge opening in the discharge hood simultaneously with the discharge of the aggregate. U.S. Pat. No. 4,266,916 discloses a mobile cement block production plant. The plant is comprised of a mobile block producing station mounted on the bed of a vehicle and a mobile block curing station, independently movable with respect to the block producing station, with the curing station comprised of a trailer having a bed, and mounted on the trailer bed are at least two block curing kilns for steam curing of blocks, each of the kilns being capable of independent function with respect to the other, and each of the kilns having an associated extendible canopy which may be extended from kilns toward the block producing station so that blocks may be continuously manufactured and cured, a canopy from one extendible station being used for steam curing of blocks while block previously steam cured in the other may be loaded. U.S. Pat. No. 4,298,288 sets forth a mobile concreting apparatus and method which may be used, in particular, for on-site construction of swimming pools. It includes a vehicle supporting a plurality of containers, each adapted to contain one of the ingredients of concrete. Each container is provided with its own ingredient feeder which feeds the ingredients to a mixing device mounted on the vehicle to create a concrete slurry. The slurry is transferred from the mixing device to the surface to be coated by a structure including a slurry pump, a hose and a nozzle. Each ingredient feeder can be individually varied in the rate at which it feeds its ingredient so that the relative composition of the slurry, and the flow rate of the slurry, can be rapidly and selectively varied on the job site to meet the particular requirements for each job. In addition, feed rate settings which provide a desirable composition and overall feed rate can be noted and reproduced on subsequent occasions when the same composition and feed rate are desired. U.S. Pat. No. 4,494,903 provides a method and an apparatus for supplying freshly made concrete. Containers having two compartments are used, one compartment for aggregate and a companion compartment for cement. The container compartments are loaded from the top and are emptied simultaneously or one after another through apertures at the bottom of each compartment opened and closed by manually or power operated gates. The top of the compartments is closed by covers which protect against humidity infiltration or humidity loss. The contents are discharged through the respective aperture onto a receiving conveyor which carries the contents into an adjacent mixer where they are mixed together with the specified amount of water and specified additives which are measured out and introduced by appropriate apparatus mounted on or near the mixer to make the eventual viscous concrete. U.S. Pat. No. 4,775,275 describes an improved mobile batch plant that is entirely self-erecting and completely contained as operated between transport and functional modes by a single operator. A truck-towed main frame hingedly supports a tower assembly that includes cement storage and weigh bins and water storage and weigh tanks proximate a materials release point to be received by a mixer. An aggregate and/or sand hopper and conveyor are located forward on the main frame and these serve to move aggregate materials to the release point. A hydraulic linear actuator system operates to move the tower assembly between the vertical operational position and the horizontal transport position where conveyor and tower are compacted against the main frame. U.S. Pat. No. 4,971,476 provides a road reconditioning plant for excavating an existing roadway and using excavated roadway material for forming a renewed roadway, the road reconditioning plant includes; an excavator capable of releasing existing roadway material to a depth of at least about 25 cm while subdividing released material to form aggregate and a chassis for carrying the excavator for advancing movement along the roadway; a drive for advancing the chassis along the existing roadway; an adjustable leveling jack on the chassis remote from the excavator for positioning the excavator to excavate roadway material to a depth of at least about 25 cm; a housing including a blade member spaced from the excavator for forming a segregating chamber wherein released roadway material can pass in a downstream direction beyond the excavator; a blender for receiving aggregate discharge for the excavator, the blender receives cement and water for forming a binder to be blended with aggregate while advanced rearwardly along the chassis in relation to the direction of forward advancing movement by the chassis; and a discharge device at the rear portion of the chassis for discharging blended aggregate and binder from the blender onto the excavated roadway. U.S. Pat. No. 5,131,788 sets forth a mobile, self propelled pothole patching vehicle is provided having a truck chassis and cab. The pothole patching vehicle includes an asphalt conveyor system for delivering asphalt to the road surface from a storage hopper mounted on the chassis. The conveyor system is uncoupled from the hopper and is movable with respect to the rest of the vehicle both longitudinally along the axis of the vehicle and transversely in a side-to-side swiveling motion. The conveyor is provided with a conveyor housing having a slotted top panel through which the asphalt passes into the conveyor interior. A conveyor mount slidably receives the conveyor and is pivotally coupled to the discharge port and the chassis for lateral swivelling motion of the extendible conveyor. During longitudinal and lateral movement of the conveyor, the discharge port opening into the housing interior remains within the ambit of the slotted portion of the top panel for continuous delivery of asphalt. The pothole patching vehicle of the present invention also includes a heated tamper for providing a smooth finish to the freshly packed asphalt and which minimizes asphalt sticking to the tamper. The heated tamper is also utilized to heat air from a compressed air source for pre-drying potholes before being filled. U.S. Pat. No. 5,328,105 describes a transportable processing unit for producing a pumpable, essentially homogeneous admixed material suitable for use as substitute fuel or for thermal destruction by incineration, the processing unit including a closed mixing vessel mounted on a movable base member the vessel adapted to receive feedstock material from an adjacent on site holding facility through at least one entry port and to receive intermediate process material through at least one inlet port and a process material exit port as well as a mixing device located in the vessel interior. The processing unit of the present invention also has a conduit for conveying process material away from the mixing vessel, which is connected to the mixing vessel exit port, and at least one particle sizing device mounted on the moveable base member which has an inlet in fluid communication with a second end of the process material conveying conduit and at least one diverter outlet which is in fluid communication with the intermediate process material inlet port of the mixing vessel. The moveable base is preferably a transportable member such as a tractor trailer or a transportation skid. U.S. Pat. No. 5,354,145 discloses an ambient temperature applied asphalt emulsion material is disclosed for repairing traffic-bearing surfaces. A method of applying the asphalt emulsion material for quick hardening by the addition of a hardening agent is shown. An applicator wand which applies the emulsion and hardening agent mixture to a surface and smoothes the applied material for hardening level with the surface. U.S. Pat. No. 5,474,379 teaches an improved portable, large volume cement mixer that includes a self-supporting inclined plane secured atop a wheeled main frame that provides basic structural support without the need for ancillary lifting equipment. The inclined plane is constructed in upper and lower hinged truss beams, upwardly hinged for operation and downwardly hinged for transport. A trolley carrying a cement mixer drum is then movable along the length of the inclined plane during operation, whereupon large batches of cement may be mixed and dispensed into waiting local carriers or trucks. U.S. Pat. No. 6,007,233 sets forth a mobile apparatus for mixing and dispensing mixtures from an ingredients container including a hopper with a channel-shaped floor portion containing a screw auger. A cover over the screw auger may be raised so that a gap between the cover and the hopper walls allows metered amounts of ingredients to be conveyed by the screw auger to a separate mixer and a dispenser. The mixer and dispenser can be in the form of a tapering ribbon-blade mixer located in a frusto conical hollow body pivotally, slidably and extendably mounted at the rear of a transport vehicle. The mixer and dispenser can be pivotally mounted to a bracket mounted on rails to move slidably across the width of the transport vehicle. U.S. Pat. No. 6,186,654 provides a portable concrete plant capable of producing up to 240 to 300 cubic yards or more of concrete per hour is disclosed in which two hauling trailers, a mixer trailer and an aggregate trailer, both serve as the transport vehicles and as foundation for the completely erected plant. The aggregate trailer includes three bins used respectively for sand, fine aggregate and course aggregate. Weigh belts convey weighed and humidity measured amounts of sand and aggregate from discrete open top bins to a batch aggregate loading belt for batch loading of a compulsory mixer on the mixer trailer. The side of the aggregate trailer is provided with a bulkhead for an earthen or gravel ramp with large width bins enabling a single loader to supply the high volume of sand and aggregate required. The mixer trailer supports a twin shaft compulsory mixer on a foundation pad which is top loading for concrete constituents and bottom emptying to an elevating and concrete discharge point to awaiting trucks. Pivotally mounted to the mixer trailer from a horizontal transport disposition to a vertically erect operating position are a multi-compartment air loaded, gravity feed cement silo, and weigh hopper for batch weighing of concrete and discharge to the underlying compulsory mixer. Provision is made for the axles located at the rear of the trailer to steer so that precision joining of the plant components can easily occur.

Thus, the prior art contains a variety of devices for the manipulation of a raw material from which a road surface may be fabricated. Included within the prior art are also various portable cement plants which are capable of being disassembled, transported, and reassembled at a desired location.

During the conventional practice of a road-laying or patching operation, it is typically the case that the raw material from which the road surface or the like is to be fabricated is transported to the site of its use from a facility at which such raw material is initially manufactured or mixed. This is because road laying and road patching operations always occur at different locations along the roads within the state or nation and construction of a concrete or asphalt plant at the site of a repair or road laying is impractical owing to the temporary nature of the road laying or repair operation. Thus it has been found most economical to truck in the raw material from a remotely-located plant or other source.

While the transport of the raw material from which a road or road repair is to be made to the point of its use has found widespread use, such an arrangement is not without its inherent disadvantages. For example, concrete which is prepared at a remote location from its point of use, by virtue of the necessity of its transport, is not wholly fresh at the time of its use owing to the time involved in loading the transporting vehicle, the actual transportation itself, plus the unload time from the transporting vessel (i.e., truck) to the equipment used in forming the road surface, repair, or other finished structure. Often, prior art methods are severely limited by these time lag elements to the extent that the use of fast-setting concretes are limited.

In addition, when providing road surfaces and the like according to prior art methods using concretes, etc., which are produced at a location that is remote from the point of use of the materials, batch-to-batch inconsistencies can occur, which result in less uniformity in the finished road or other construction.

Further, when providing road surfaces and the like according to prior art methods using concretes, etc., which are produced at a location that is remote from the point of use of the materials, there is often a large amount of wasted concrete mix, since it is difficult to estimate the exact amount of mix required for the specific job, and the tendency is to provide more material than is needed to complete the job (as opposed to erring on the “short” side) which results in almost all cases of wasted amounts concrete mixes which are not needed and which must be disposed of

Further still, when providing road surfaces and the like according to prior art methods using concretes, etc., which are produced at a location that is remote from the point of use of the materials, there is a reduced degree of flexibility with regards to when the workers associated with the surface-making process may cease operations. Quitting time is dictated by when the latest batch which has been brought on site is entirely used, for stopping before the entire batch is used results in wasted concrete. Such wastes can occur in cases where unforeseen events require operations to cease.

Finally, when providing road surfaces and the like according to prior art methods using concretes, etc., which are produced at a location that is remote from the point of use of the materials, the vessels used to haul the mixes from their production site to the point of use are expensive to procure, operate, and maintain.

### SUMMARY OF THE INVENTION

In one aspect, the present invention provides a mobile volumetric mixing plant for producing concrete and grouts comprising: 1) a plant motion truck; 2) a first conveyor means having a receiving end and a discharge end wherein the first conveyor means is disposed over the top of the truck and is oriented so that the receiving end is disposed in the front of the truck and the discharge end is disposed over the rear of the cab of the truck; 3) a mobile concrete plant coupled to the plant motion truck; 4) a supply truck, having a storage vessel containing contents selected from the group consisting of: aggregates, and water. The storage vessel on the second truck has an outlet portion, wherein the outlet portion of the supply truck is in sufficient proximity to the receiving end of the first conveyor means to enable the contents of the truck to enter the first conveyor means. In a preferred embodiment, the plant motion truck and the supply truck are both in motion at the same speed relative to the ground. The concrete plant includes a) a cement bin for storing cement powder, the bin having a top portion comprising an opening; b) at least two aggregate bins having a top portion comprising an opening; c) a second conveyor to place aggregates received from the first conveyor into proper the aggregate bins; d) a third conveyor means for transferring cement powder and aggregates, or the like from their respective storage bins to a point at which these concrete precursors are mixed together with water and admixtures, wherein the third conveyor means has a receiving portion and a delivery portion; e) two strikeoff gates for metering aggregates or the like on the conveyor; f) a rotary vane feeder for metering cement powder or the like onto the third conveyor means; g) means for providing water and admixtures to the cement powder and other concrete precursors disposed on the third conveyor means; h) a mixing auger having an inlet portion and an outlet portion, wherein the inlet portion of the mixing auger is disposed at the delivery end of the third conveyor means; and i) a means for transferring concrete having an inlet and an outlet, wherein its inlet is disposed to be adapted to receive fresh concrete which exits the outlet portion of the mixing auger and wherein the outlet is disposed sufficiently to enable the fresh concrete to be used in forming a road surface. Preferably, the opening of at least one and more preferably all, of the aggregate bins are disposed to receive raw materials from the discharge end of the second conveyor means, which serves as a shuttle conveyor to transfer materials received from the discharge end of the first conveyor to the desired aggregate bins.

In another aspect, the present invention comprises a mobile device useful for onsite mixing of concrete precursors to form a fresh concrete which comprises:

a wheeled-base portion that includes: a) at least one storage compartment for containing a concrete precursor, wherein the storage compartment has an outlet; b) a conveyor belt means having a receiving end and a discharge end, the conveyor means being disposed beneath the storage compartment in sufficient proximity to receive a quantity of the concrete precursor, the concrete precursor having a portion which contacts the conveyor belt means and a top surface portion; c) two adjustable strikeoff gates means disposed along the travel path of the conveyor in a position that is above the conveyor and in contact with the top surface of the quantity of the concrete precursor being transported; d) a cement powder storage compartment having an outlet, wherein the outlet is disposed in sufficient proximity to deliver a quantity of cement to the top surface of the concrete precursor as it travels along the conveyor, wherein the outlet includes an airlock rotary vane feeder; e) an auger inlet chamber having a bottom portion and disposed at the delivery end of the conveyor belt means, which inlet chamber is adapted to receive the cement and concrete precursor from the delivery end of the conveyor belt, wherein the auger inlet chamber includes a means for adding a desired quantity of water to the cement powder and concrete precursor(s) which enter the chamber; and f) a screw auger having an inlet end and an outlet end, wherein the inlet end is disposed in the bottom of the auger inlet chamber and is adapted to receive the cement powder, concrete precursor, water, and admixtures.

### BRIEF DESCRIPTION OF DRAWINGS

In the annexed drawings:

FIG. 1 is a side view of a device according to the invention that is useful for providing fresh concrete at a job site;

FIG. 1A is an overhead view of the storage compartment of a device according to the invention;

FIG. 1B is an overhead view of the storage compartment of a device according to the invention;

FIG. 2 is a side view of a system according to the invention, wherein a device according to the invention that is useful for providing fresh concrete at a job site is being supplied with a concrete precursor material from a conveyor means;

FIG. 3 is a side view of a system according to the invention, wherein a device according to the invention that is useful for providing fresh concrete at a job site is being supplied with a concrete precursor material from a truck; and

FIG. 4 is a side view of a system according to the invention, wherein a system according to the invention that is useful for providing fresh concrete at a job site is being pneumatically supplied with a cement powder from a truck.

### DETAILED DESCRIPTION

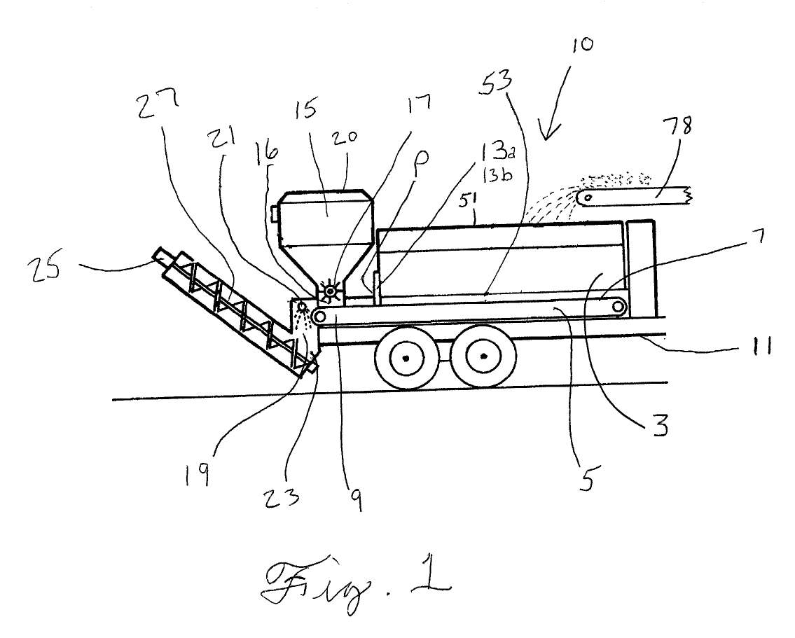

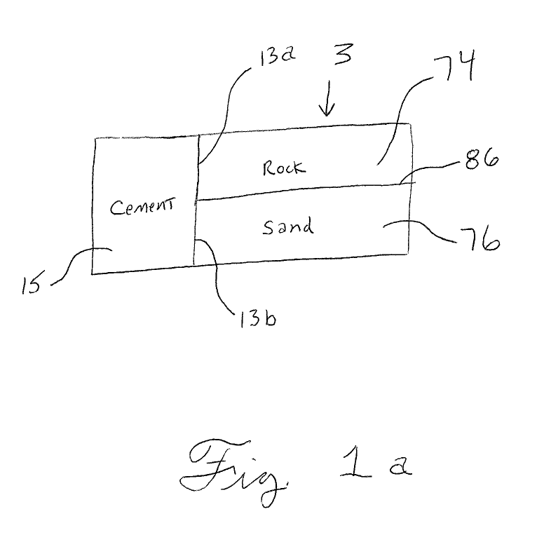

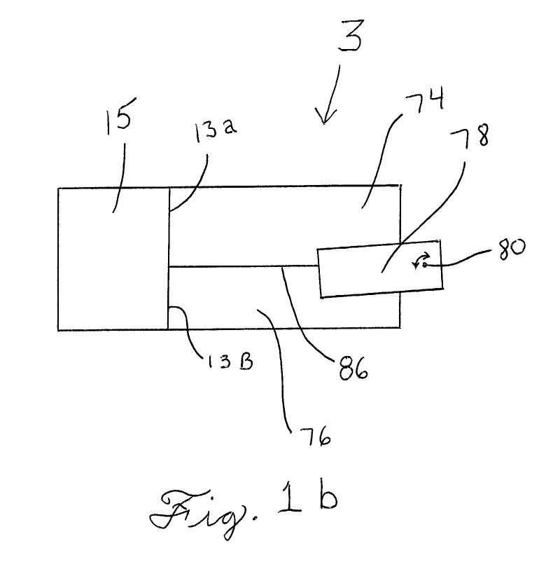

Referring to the drawings and initially to FIG. 1 there is shown a device 10 according to one aspect of the invention that is useful for providing fresh concrete at a job site. This mobile device is useful for on-site mixing of concrete precursors to form a fresh concrete which includes a wheeled-base portion 11, a storage compartment 3 for containing concrete precursors, such as aggregates and the like. The storage compartment 3 is generally shaped like a cylindrical, hollow rectangular, or other geometric form used as storage vessels by those skilled in the art for containing such aggregates, or the like. Such vessels typically comprise a top portion 51 into which gravel, aggregates, and the like may be loaded, and is in one preferred form of the invention open to the atmosphere. The storage compartment 3 of a device according to the invention includes an outlet portion or opening disposed at its bottom portion 53, through which the aggregates or the like that are contained in the storage compartment may be discharged from storage compartment 3.

A device according to the invention includes a conveyor means 5 which has a receiving end 7 and a discharge end 9. The conveyor means 5 is disposed beneath said storage compartment 3 in sufficient proximity to receive a quantity of the concrete precursors that are contained in the storage compartment 3. A portion of the concrete precursor (aggregate, etc.) that is disposed on the moving conveyor means 5 is in contact with the conveyor belt means, and a portion of the concrete precursor that is disposed on the moving conveyor means 5 comprises the top surface portion of the concrete precursor.

According to a preferred form of the invention, the storage compartment 3 is divided into separate bins by means of partition 86, as is more clearly shown in the overhead view of FIG. 1A. Along the path of travel of the conveyor means 5, which is preferably a belt conveyor, there are two adjustable gate means 13a and 13b (FIG. 1A) disposed in a position that is above the conveyor means 5 and in contact with the top surface of said quantity of said concrete precursor. The adjustable gates means are disposed so as to be vertically adjustable with respect to the plane represented by the belt of the first conveyor means, so as to only permit a desired thickness of concrete precursor material to pass between the space defined by the lower surface of the adjustable gate means and the surface of the conveyor means 5. By such design, the amount of concrete precursor which passes on the conveyor belt means is conveniently controlled.

There is a cement powder storage compartment 15 which has an outlet 16. The purpose of the cement storage compartment is to contain the cement powder which is used to form a concrete according to the invention, by admixture of the cement powder with the concrete precursors in the presence of a desired amount of water, which mixing, according to a preferred form of the present invention, is conducted in an auger 27. The outlet 16 of the cement powder storage compartment 15 is disposed directly above and in sufficient proximity to the concrete precursor (aggregate, etc.) that is present on the moving conveyor means 5 that when cement powder is caused to exit the cement storage compartment 15, it contacts the concrete precursor materials on the conveyor belt means and is transmitted with these concrete precursor materials to an auger inlet chamber 19. According to a preferred form of the invention, the outlet 16 of the cement powder storage compartment is equipped with an airlock rotary vane feeder 17, as such airlock rotary vane feeders are known to those skilled in the art. This feature provides a high degree of accuracy in metering the correct amount of cement powder. The belt on the first conveyor means used for moving the cement powder and concrete precursors has a width dimension of any width between about 18.00 inches and 40.00 inches, including every hundredth inch therebetween, and preferably moves at a linear rate of travel of any rate between 0.5 and 1000 feet per minute, by virtue of a motor (preferably hydraulic) and associated pulleys and the like, the use of which are well-known in the conveyor arts.

Disposed within the auger inlet chamber 19 is a means for adding water 21 to the mixture of concrete precursors (aggregates, etc.) and cement powder, which may merely be a tube through which water from a source external to the system may be admitted, to ensure that the desired amount of water is present in the mixture. Any other admixture of materials which are desired to be incorporated into the concretes produced according to the invention may be added at this location as well.

By virtue of the nature of the conveyor means 5, there is a discharge end 9 of the conveyor belt means which discharge end 9 is disposed in such sufficient proximity to the auger inlet chamber 19 that the contents resting atop the conveyor means 5 are caused to fall into the auger inlet chamber 19.

The present invention includes an auger mixer 27 disposed with its inlet portion 23 at the bottom of the auger inlet chamber, so that the materials which are delivered to the auger inlet chamber 19 from the discharge end 9 of the conveyor means are caused to enter the inlet portion 23 of the auger mixer 27. The auger mixer 27 contains an auger screw, which, as is well known in the art, is useful in mixing various solid/liquid materials by virtue of the rotation of the auger within the outer casing or tube component of the mixing auger 27. The auger mixer 27 also includes an outlet portion 25, from which the finished, fresh-mixed concrete comprising the concrete precursors (aggregates, gravel, etc.), cement powder, and water emerges from the auger mixer 27.

In FIG. 1A is shown an overhead view of the storage compartment 3, showing its division into separate compartments according to a preferred form of the invention. Here are shown the locations of gates means 13a and 13b, a rock storage compartment 74, a sand storage compartment 76, and the relative location of a cement storage compartment 15.

In FIG. 1B is shown an overhead view of the storage compartment 3, showing its division into separate compartments according to a preferred form of the invention. Here are shown the locations of gates means 13a and 13b, a rock storage compartment 74, a sand storage compartment 76, and the relative location of the a cement storage compartment 15. Additionally, there is shown conveying means 78, which is preferably a belt conveyor, which is used to selectively convey precursor materials to the desired respective bins of the storage compartment by virtue of the ability of conveying means 78 to be rotated in an arc about pivot point 80, as described later.

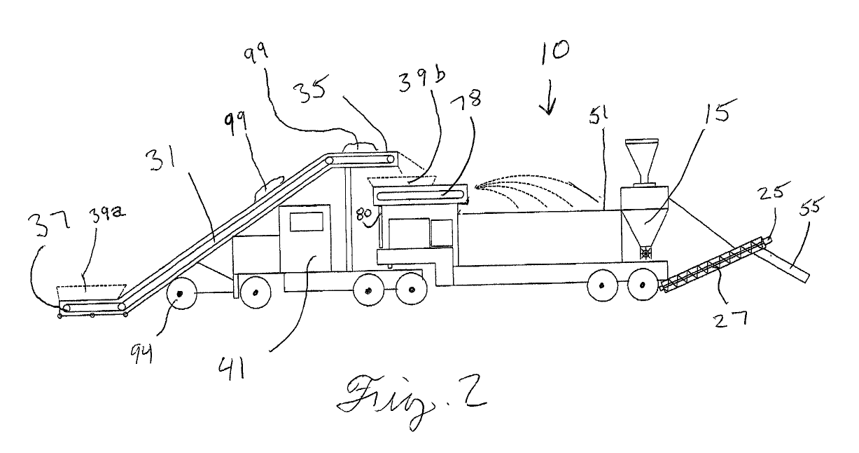

In FIG. 2 is shown a device 10 as shown in FIG. 1, which is in use in the field, and which is being used in combination with conveyor means 31, which is preferably a belt conveyor, for the purpose of providing a continuous supply of concrete precursor materials 99 (aggregates, etc.) to the storage compartment 3 of the device 10 with the aid of conveyor means 78. The conveyor means 31 includes a receiving end 37 and a discharge end 35. The receiving end 37 of the conveyor 31 may optionally include a receiving hopper 39a to assist in conveying the precursor materials. The conveyor means 31 is preferably self-contained and powered by a diesel engine with a hydraulic pump, and is mounted on an axle 94 to which wheels are attached, thus conferring upon the conveyor means 31 the ability to travel at the same speed with the truck 41 which is used in a preferred form of the invention to cause the whole combination to be mobile during the production of the finished concrete that exits the exit chute 55 and which may be used by workers to prepare a road surface or the like. For convenience, the conveyor means 31 may be towed to the jobsite and attached to the front end of truck 41. Under such an arrangement, the whole concrete manufacturing facility is mobilized and may move at the same rate at which the road surface is prepared.

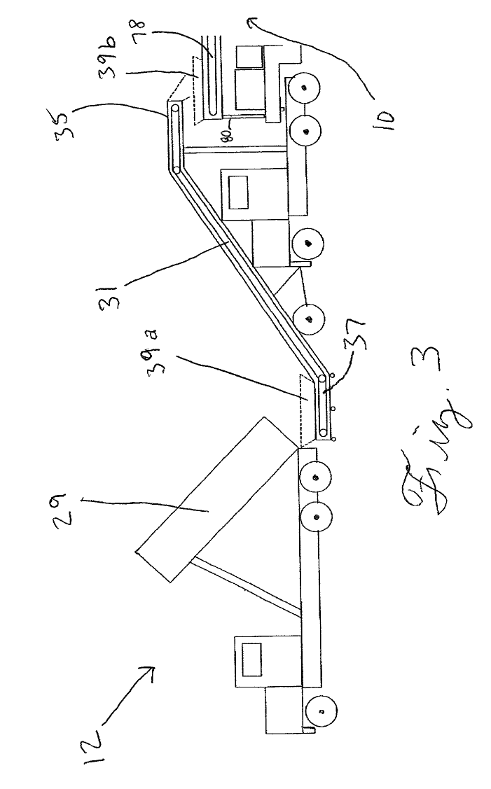

In FIG. 3 is shown the conveyor means 31 from FIG. 2 that is used to supply concrete precursors to a device 10 according to the invention. In this FIG. 3, there is shown a supply truck 12 which includes a storage vessel 29, which truck and its associated storage vessel are disposed in such proximity that the contents of the storage vessel may by gravity or by live-bottom trailer be caused to enter the receiving end 37 of the conveyor means 31 for transfer to the discharge end 35 of the conveyor means 31, and ultimately to the bins of the storage compartment 3 of the device 10 according to the invention. To assist in the loading of the storage bins 74 and 76 (FIG. 1B) there is a conveyor means 78, which is preferably a belt conveyor, which has a receiving end and a discharge end that is disposed so that its receiving end receives materials from the discharge end of conveyor means 31. The receiving end of the conveyor means 78 may conveniently include a receiving hopper 39b that receives and discharges such materials into the desired bin of storage compartment 3 by virtue of its ability to be pivoted about pivot point 80 (FIG. 1B) so that the discharge end of conveyor means 78 is above the desired bin. This aspect is shown in FIG. 1B, wherein the second conveyor means 78 may be selectively pivoted about a point 80 so as to have its discharge end disposed above either the bins 74 or 76. Since the supply truck 12 and the conveyor means 31 have the ability to move along at the same speed with the truck 41 which is used in a preferred form of the invention to cause the whole combination to be mobile during the production of a finished concrete which exits the exit chute 55, (FIG. 2) and may be used by workers to prepare a road surface or the like. Under such an arrangement, the whole concrete manufacturing facility, including the raw material supply, is mobilized and may move at the same rate at which the road surface is prepared.

It will be appreciated by those skilled in the art that there are many functional equivalents possible for the truck 12 in this FIG. 3. Such a truck functions essentially as a supply vehicle for the conveyor 31, and supply vehicles may be varied to include vehicles that can carry water and aggregates. Included within the functional equivalents of the truck 12 are bottom trailers, drop-deck open frame trailers, truck chasis', and trailer-mounted units. Thus the word “truck” when used in this specification and the appended claims in the context of that shown for the truck 12 in FIG. 3 is intended to include all of such equivalents.

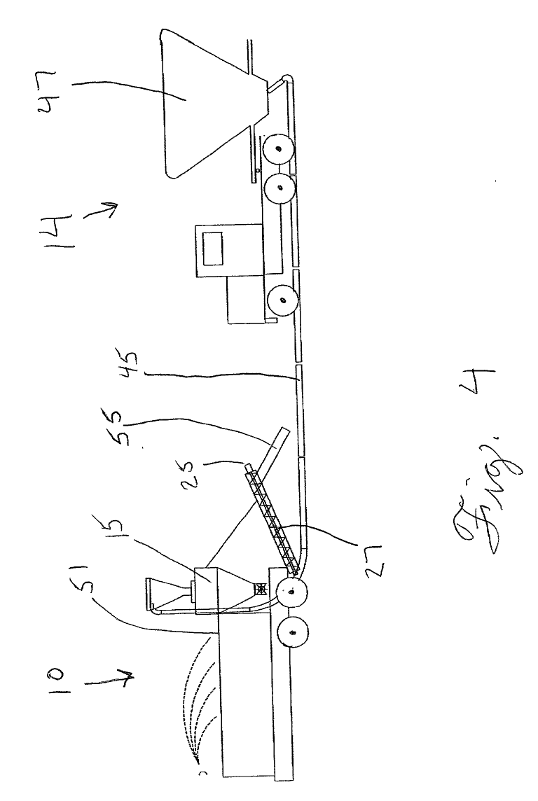

FIG. 4 shows a supply truck 14 having a storage vessel 47 which contains cement powder. The cement powder from the storage vessel 47 is pneumatically conveyed to the cement powder storage compartment 15 of a device 10 according to the invention, through a pneumatic hose 45, as the pneumatic conveying of dry cement powder (such as Portland cement) through a hose is known in the art. Since the supply trucks 12 and 14, and the conveyor means 31 have the ability to move along at the same speed with the truck 41 which is used in a preferred form of the invention to cause the whole combination to be mobile during the production of a finished concrete which exits the exit chute 55, (FIG. 2) and may be used by workers to prepare a road surface or the like.

Thus, in one form of the invention, a mobile volumetric mixing plant for producing concrete comprises a plant motion truck such as 41 shown in FIG. 2. This truck may be any truck available in the marketplace which is capable of pulling a load of about 80,000 pounds, and is preferably a Day Cab model 3-axle tractor.

When viewed as a whole, the invention in one aspect is a combination of various pieces of equipment which includes a first conveyor means 31 having a loading end 37 and a discharge end 35, wherein the first conveyor means 31 is disposed over the top of a plant motion truck 41 and is oriented so that the loading end 37 of this conveyor means is disposed in the front of the plant motion truck 41 and the discharge end 35 is disposed over the rear of the cab of the truck 41. There is a concrete plant 10 coupled to the plant motion truck 41, wherein the concrete plant comprises a storage compartment 15, which in one preferred form of the invention is a cement powder bin having a top portion 20 comprising an opening. In one preferred form of the invention there is also a concrete precursor bin 3 having a top portion comprising an opening 51. The concrete precursor bin 3 is useful in storing aggregates, gravels, or the like which are to be incorporated into a finished concrete according to the invention. In an alternate form of the invention the concrete precursor bin may be divided into separate compartments made distinct from one another by means of partition wall 86 (FIG. 1a) or the like and filled with two different materials. There is a second conveyor means 78 which has a receiving end and a discharge end. The purpose of the second conveyor means is to assist in the correct filling of the respective bins 74 or 76 with materials provided by the first conveying means 31. The second conveyor means 78 may be selectively directed to discharge its contents into either of the storage bins, depending upon the materials supplied from the first conveying means 31. In a preferred form of the invention, the opening 51 of the concrete precursor bins are preferably disposed to receive raw materials from the discharge end of the second conveyor means 78, which for convenience may include the use of a hopper 39b.

There is also a third conveyor means 5 for transferring cement powder and concrete precursors from the bin(s), wherein the third conveyor means 5 has a receiving end portion 7 and a discharge end portion 9. Disposed at the end of the storage compartment 3 there are valve means 13a and 13b which in a preferred form of the invention are vertically adjustable flat strike-off gates that are each shaped in the form of a rectangular solid having a first front face, a second front face, a top surface, a bottom surface, and two side wall portions, which gates are useful for controlling the amount of concrete precursor materials which exit the underside of the storage compartment 3 at point P in FIG. 1 by virtue of the distance between the conveyor belt itself and the bottom surface of the gate. For example, if the flat bottom surface of a strike-off gate is disposed at a distance of three inches directly above the conveyor belt, then the physical configuration of the amount of concrete precursor which emerges from beneath the storage compartment 3 may be no greater than 3 inches in height, its width dictated by the width of the conveyor belt, as the width of the belt is greater than the width of the strike-off gate. The width of the conveyor belt may be any width desired, however, it is most preferably any width between about 18 inches and about 40 inches, with a width of about 30 inches being most preferred. Preferably, the strike-off gates 13a and 13b are associated with controlling the amount of the contents of bins 74 and 76 respectively, transferred.

Additionally, there is a rotary vane feeder 17 for metering cement onto the third conveyor means, and a means for providing water 21 to the cement powder and aggregate disposed on the third conveyor means at or in the near vicinity of its delivery end 9. At the delivery end 9 of the third conveyor means 5 there is disposed the inlet portion 23 of a mixing auger having also an outlet portion 25, wherein the inlet portion 23 is adapted to receive the cement powder and concrete precursor materials as they fall under the force of gravity from the third conveyor means 5. The invention may also include a means for transferring concrete, which means has an inlet and an outlet, wherein the inlet is disposed to be adapted to receive fresh concrete which exits the outlet portion 25 of the mixing auger 27, and wherein the outlet of the means for transferring concrete is disposed sufficiently to enable workers the fresh concrete to be used in forming a road surface. Such means for transferring concrete are known to those skilled in the art, and may include a simple chute, or a hydraulic concrete pump, as such pumps are known in the art.

The invention includes the use of supply truck 12, having contents selected from the group consisting of: aggregates, or other solids. The supply truck has a discharge portion, wherein said discharge portion of the supply truck is in sufficient proximity to the loading end of the first conveyor means to enable said contents to enter said first conveyor means, preferably by gravitational forces or other methods known in the art. The trucks 41 and 12 may be caused to move at the same rate of speed at which the workers consume concrete during the production of a road surface or the like, thus providing a mobile concrete plant for generating a road surface or the like at the point of use of the concrete, in exactly the required amount and at the needed rate.

By the present invention, there is no amount of concrete which is wasted. Further, by the invention, the concrete which is produced and used in preparing the road surface or the like is as fresh as can be by virtue of its being prepared on-site. This is of special benefit in cases where it is desired to employ a fast-setting concrete, for, according to methods of prior art where such fast-setting concretes are prepared in a location that is remote from the point of use, the loading of the conveying vessel (usually a truck), coupled with the transportation time and unload time becomes a critical factor, and owing to uncontrollable inconsistencies in loading and transportation, a non-uniform road surface or the like is in many cases resultant. Such non-uniformity results in the long term of different expansion/contraction rates of the different concretes, which is a source of premature decay/deterioration of a road surface. By the present invention, the foregoing problems are alleviated.

Another advantage inherent in producing a road surface or the like using the present invention in its various forms is that the concrete surfaces have a higher “early strength.” “Early strength” is the strength of the concrete surface expressed in psi, Kpa, or Mpa. Concretes produces using a device configuration and process according to the invention have early strengths as high as 3,000 MPa in as short of time periods of 1.5 hours from the initial mixing of materials.

In addition to concretes prepared according to the invention being more uniform, fresh and consistent, there is no waste associated with the present process. Further, there are no cold joints, the process may be started and stopped as desired, and a high degree of slump control is possible. “Slump” is generally understood by those skilled in the art to mean the workability of concrete grout. Water-reducing additives reduce the normal requirement of water and increases the slump.

Another inherent advantage of preparing a road surface or the like using the present invention is that less expensive equipment is needed to haul the concrete precursor materials, which, according to prior art methods must include the use of traditional ready-mix trucks. The present invention eliminates the need for such ready-mix trucks as well as the costs associated with their operation and maintenance.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. For example, it is possible to use a device according to the invention in the preparation of other materials, such as flowable fills, slurries, pipeline construction materials, grouts, etc. Accordingly, the presently disclosed invention is intended to cover all such modifications and alterations, and is limited only by the scope of the claims which follow.

I claim:

1) A mobile device useful for on-site mixing of concrete precursors to form a fresh concrete which comprises a wheeled-base portion that further includes:
a) at least one storage compartment for containing a concrete precursor, wherein said storage compartment comprises a bottom portion having an outlet portion;
b) a conveyor belt means having a receiving end and a discharge end, said conveyor belt means being disposed beneath said storage compartment in sufficient proximity to the outlet portion of the storage compartment to receive a quantity of said concrete precursor, with the concrete precursor comprising a portion that contacts the conveyor belt means and a top surface portion;
c) at least one adjustable gate means disposed along the travel path of said conveyor in a position that is above the conveyor belt and in contact with the top surface of said quantity of said concrete precursor;
d) a cement powder storage compartment having an outlet, wherein said outlet is disposed in sufficient proximity to deliver a quantity of cement powder to the top surface of said concrete precursor as it travels along said conveyor, wherein said outlet of said cement powder storage compartment includes an airlock rotary vane feeder,
e) an auger inlet chamber having a bottom portion and disposed at the delivery end of said conveyor belt means, which inlet chamber is adapted to receive the cement powder and concrete precursor from the delivery end of the conveyor belt means, wherein said auger inlet chamber includes a means for adding a desired quantity of water to said cement powder and concrete precursor which enters said inlet chamber; and
f) a screw auger having an inlet end and an outlet end, wherein said inlet end is disposed in the bottom of said auger inlet chamber and is adapted to receive said cement powder, concrete precursor, and water,
from which fresh concrete may be caused to emerge from said outlet end of said screw auger during its rotation.

2) A mobile device according to claim 1 and further comprising:
g) a means for conveying fresh concrete which exits the outlet end of said screw auger to a road surface.

3) A mobile device according to claim 1 wherein said means for conveying fresh concrete comprises a chute.

4) A mobile device according to claim 1 wherein said storage compartment includes a concrete precursor that comprises one or more materials selected from the group consisting of: coarse aggregates and fine aggregates.

5) A mobile device according to claim 4 wherein said conveyor belt means has a width dimension of any width between about 18.00 inches and 40.00 inches, including every hundredth inch therebetween, and wherein said conveyor belt is caused to move at a linear rate of travel of any rate between 0.5 and 1000 feet per minute.

6) A mobile device according to claim 2 wherein said device is effectively connected to a truck, which truck is moving at a rate of speed of any rate between 0.10 miles per hour and 10 miles per hour.

7) A mobile device according to claim 1 wherein said storage compartment comprises a plurality of compartments, separated by at least one partition means.

8) A mobile device useful for on-site mixing of concrete precursors to form a fresh concrete which comprises a wheeled-base portion that further includes:
a) at least one storage compartment for containing a concrete precursor, wherein said storage compartment has a bottom portion having an outlet, and wherein said storage compartment contains a concrete precursor that comprises one or more materials selected from the group consisting of: coarse aggregates, or fine aggregates;
b) a conveyor belt means having a receiving end and a discharge end, said conveyor belt means being disposed beneath said storage compartment in sufficient proximity to the outlet portion of the storage compartment to receive a quantity of said concrete precursor, with the concrete precursor comprising a portion that contacts the conveyor belt means and a top surface portion, and wherein said conveyor belt means has a width dimension of any width between about 18.00 inches and 40.00 inches, including every hundredth inch therebetween, and wherein said conveyor belt moves at a linear rate of travel of any rate between 0.5 and 1000 feet per minute;
c) an adjustable gate means disposed along the travel path of said conveyor in a position that is above the conveyor belt and in contact with the top surface portion of said concrete precursor;
d) a cement powder storage compartment having an outlet, wherein said outlet is disposed in sufficient proximity to deliver a quantity of cement powder to the top surface of said concrete precursor as it travels along said conveyor, wherein said outlet includes an airlock rotary vane feeder;
e) an auger inlet chamber having a bottom portion and disposed at the delivery end of said conveyor belt means, which inlet chamber is adapted to receive the cement powder and concrete precursor from the delivery end of the conveyor belt, wherein said auger inlet chamber includes a means for adding a desired quantity of water to said cement powder and concrete precursor which enters said chamber;
f) a screw auger having an inlet end and an outlet end, wherein said inlet end is disposed in the bottom of said auger inlet chamber and is adapted to receive said cement powder, concrete precursor, and water, wherein fresh concrete is caused to emerge from said outlet end of said screw auger during its rotation; and
g) a means for conveying fresh concrete which exits the outlet end of said screw auger to a road surface,
wherein said device is effectively connected to a truck which is moving at a rate of speed of any rate between 0.10 miles per hour and 10 miles per hour.

9) A process for producing a set concrete structure which comprises the steps of:
a) providing a mobile device according to claim 1;
b) directing said fresh concrete emerging from said device to an excavation or hole in the ground;
c) forming the surface of said concrete into a desired form; and
d) allowing said concrete to harden or set.

10) A process according to claim 9 wherein said concrete has an early strength of at least 3000 psi after a time period no greater than 90 minutes.

11) A process according to claim 9 wherein said concrete structure is selected from the group consisting of: roads, road patches, airport surfaces, chemical plants, and pipeline ditch fills.

12) A process according to claim 11 in which said concrete structure is a road, and wherein said concrete is produced at a rate of 1 to 90 cubic yards per hour.

13) A process for producing a set concrete structure which comprises the steps of:
a) providing a mobile device according to claim 8;
b) directing said fresh concrete emerging from said device to an excavation or hole in the ground;
c) forming the surface of said concrete into a desired form; and
d) allowing said concrete to harden or set.

14) A process for producing a set concrete structure which comprises the steps of:
a) providing a mobile device according to claim 1;
b) directing said fresh concrete emerging from said device to an excavation or hole in the ground;
c) forming the surface of said concrete into a desired form; and
d) allowing said concrete to harden or set.

15) A process according to claim 14 wherein said concrete has an early strength of at least 3000 psi after a time period no greater than 90 minutes.

16) A process according to claim 14 wherein said concrete structure is selected from the group consisting of: roads, road patches, airport surfaces, chemical plants, and pipeline ditch fills.

17) A process according to claim 16 in which said concrete structure is a road, and wherein said concrete is produced at a rate of 1-90 cubic yards per hour.

18) A mobile volumetric mixing plant for producing and laying concrete comprising:
a) a plant motion truck;
b) a first conveyor means having a receiving end and a discharge end wherein said first conveyor means is disposed over the top of said plant motion truck and is oriented so that its receiving end is disposed in the front of said truck and its discharge end is disposed to the rear of the truck's cab;
b) a second conveyor means having a receiving end and a discharge end, wherein the receiving end of the second conveyor means is disposed to receive the materials discharged from the discharge end of said first conveyor means;
c) a concrete plant coupled to said plant motion truck, wherein said concrete plant comprises:
i) a cement powder storage compartment having a top portion and an outlet portion, wherein said outlet portion includes a rotary vane feeder for metering cement which exits said cement powder storage compartment;
ii) at least one concrete precursor storage compartment having a top portion comprising an opening;
iii) a third conveyor means for transferring cement powder and concrete precursors from their respective storage compartments, wherein said third conveyor means has a receiving end portion and a delivery end portion;
iv) a gate for metering the height of concrete precursor(s) atop said third conveyor means;
v) means for providing water to the concrete precursors and cement powder conveyed by said third conveyor means;
vi) a mixing auger having an inlet portion and an outlet portion, wherein said inlet portion of said mixing auger is disposed at the delivery end of said third conveyor means to receive the water, concrete precursors, and cement powder; and
vii) a means for transferring concrete having an inlet and an outlet, wherein said inlet is disposed to be adapted to receive fresh concrete which exits the outlet portion of said mixing auger, and wherein said outlet of said means for transferring is disposed sufficiently to enable said fresh concrete to be used in forming a road surface;
wherein said opening of said concrete precursor storage compartment is disposed to receive raw materials from the discharge end of said second conveyor means; and
d) a supply truck, having contents selected from the group consisting of: aggregates or other solids, said supply truck including a storage vessel which includes a discharge portion, wherein the discharge portion of the supply truck is in sufficient proximity to the loading end of the first conveyor means to enable the contents of the storage vessel of the supply truck to enter said first conveyor means.

19) A mobile volumetric mixing plant as in claim 18 wherein said plant motion truck and said supply truck are both caused to be in motion at the same speed relative to the ground.

20) A process for producing a set concrete structure which comprises the steps of
a) providing a mobile device according to claim 18;
b) directing said fresh concrete emerging from said device to a location selected from the group consisting of: an excavation, hole in the ground, or into the inlet of a concrete pump.

21) A process according to claim 20 wherein said concrete has an early strength of at least 3000 psi after a time period no greater than 90 minutes.

22) A process according to claim 20 wherein said concrete structure is selected from the group consisting of: roads, road patches, airport surfaces, industrial chemical plants, refineries, commercial buildings, and pipeline ditch fills.

23) A process according to claim 22 in which said concrete structure is a road, and wherein said concrete is produced at a rate of 1-90 cubic yards per hour.

24) A process according to claim 20 wherein said plant motion truck and said supply truck are both caused to be in motion at the same speed relative to the ground.

25) a process according to claim 20 further comprising the steps of:
c) forming the surface of said concrete into a desired form; and
d) allowing said concrete to harden or set.

26) A process for laying a road surface or the like which comprises the steps of:
a) providing a cement powder;
b) providing at least one material selected from the group consisting of:
coarse aggregates or fine aggregates;
c) providing water,
wherein said cement powder, said at least one of coarse aggregates or fine aggregates, and said water are contained on a moveable platform,
d) mixing said cement powder with water, and said at least one of coarse aggregates or fine aggregates in an auger mixer so as to form a fresh concrete product;
e) transferring said fresh concrete product to a location on the ground within 50 feet of the point at which said fresh concrete exits said auger, which has been prepared to receive a concrete from which a road surface or the like is to be made;
f) finishing the surface of said concrete;
g) permitting said concrete to set,
h) replenishing said cement powder, said at least one of sand, gravel, or aggregate, and said water to said platform on which they are contained in the quantities in which they are consumed, as they are consumed, in order to provide a continuous source of fresh concrete during a road surfacing operation,
wherein said moveable platform is caused to be in motion with respect to the ground at any rate between 0.10 and 10.0 miles per hour.
